(19) United States
(12) Patent Application Publication
(10) Pub. No.: US 2020/0195874 A1
(43) Pub. Date: Jun. 18, 2020

(54) Real Time Video

(71) Applicant: Nokia Solutions and Networks Oy, Espoo (FI)

(72) Inventor: Hans-Jochen MORPER, Erdweg (DE)

(21) Appl. No.: 16/623,632

(22) PCT Filed: Jun. 30, 2017
(86) PCT No.: PCT/EP2017/066259

§ 371 Date: Dec. 17, 2019

(30) Foreign Application Priority Data
Jun. 30, 2017 (EP) PCT/EP2017/066259

(51) Int. Cl. H04N 5/3745; H04N 5/345; H04N 19/172; H04N 19/523

(52) U.S. Cl. CPC H04N 5/3745; H04N 19/523; H04N 19/172; H04N 5/3456

(57) ABSTRACT

It is provided a method, comprising, for each subset of a predefined group of subsets of pixels of an image sensor: retrieving a respective predefined correlation between positions of pixels in the respective subset and positions in a subframe corresponding to the respective subset based on an identification of the respective subset; extracting pixel values of pixels of the respective subset and storing the extracted pixel values in positions of the corresponding subframe according to the predefined respective correlation; transmitting the subframe corresponding to the respective subset and the identification of the respective subset when the extracted pixel values are stored in the corresponding subframe, irrespective of a transmission timing of any of subframes corresponding to other subsets of the group; wherein the number of the different subsets in the group is equal to or larger than 2.

### FIELD OF THE INVENTION

The present invention relates to an apparatus, a method, and a computer program product related to network performance. In particular, the present invention may be related to exploiting non-mobility of a UE for improving network performance

Abbreviations

2G/3G/4G/5G 2^{nd}/3^{rd}/4^{th}/5^{th} Generation

3GPP 3^{rd} Generation Partnership Project

CCD Charge Coupled Device

fps frames per second

HD High Definition

JPEG Joint Photographic Experts Group

LL Low Latency

MOD modulo

MPEG Moving Pictures Expert Group

NTSC National Television System Committee

PAL Phase Alternating Line

### BACKGROUND OF THE INVENTION

A short description about conventional digital video transmission is given: FIG. 1-1 shows a setup where a camera is taking video frames at a given frame rate. The captured video information is passed over to a video encoder which may apply further processing as e.g. data compression which may also take into account information of previous and succeeding frames.

The data is passed over a [wireless] communication path via a transceiver unit and received at a peer side via a transceiver. Here a decoder will un-compress the data (if applicable) and further adapt it as needed (e.g. scale it to fit to a given display size).

Cameras typically operate on a per-frame mode, i.e. video information is passed from the camera to the encoder unit as full frame. A full frame comprises all the pixels of the image taken by the camera. Typical frame rates are 24, 25 29 and 50 frames per second.

Today's digital [video] cameras build on existing video formats that are based on standards of the times of analog cameras and use a full-frame transmission, i.e. 25 frames per second [fps] in PAL or 29 frames per second in NTSC. With HD and even 4K videos emerging, framerates of 50 fps become popular.

PAL is a standard designed for 25 fps in a per-line capture mode for analogue video transmission. In analogue video transmission, this means on the receiving side, that, after all lines of an image were received, the image is displayed leading to 25 Hz image rate at an analogue TV set. Such a low image rate would have been annoyingly flickering so that the image was spilt into two sub images—one having the even numbered lines, the other having the odd numbered lines. Both sub images were displayed subsequently so that an “artificial” image rate of 50 Hz could be achieved.

Optimization efforts on video capturing and encoding is very focused on higher resolution videos alongside with better compression schemes allowing to keep and transmit high quality videos. Real time video transmission only plays a minor role.

Even when 50 fps (which is at the limit of today's smart phone cameras for HD) are used as a frame rate, each video frame reaches the receiver 20 ms later than the previous frame leading to an inevitable inherent video delay of 20 ms. This delay comes on top of transmission delay and processing delay—making real time video, as it may become more and more popular in 5G mass consumer services (joint performance, gaming) and industrial applications, almost impossible.

Since today's focus of optimization is rather on video compression and since compression codecs perform best if they take into account information of previous and following frames, this will lead to even more delay coming from en-/decoding. Thus these optimizations are even more against the realization of real time video.

### SUMMARY OF THE INVENTION

It is an object of the present invention to improve the prior art.

According to a first aspect of the invention, there is provided an apparatus, comprising at least one processor, at least one memory including computer program code, and the at least one processor, with the at least one memory and the computer program code, being arranged to cause the apparatus to at least perform, for each subset of a predefined group of subsets of pixels of an image sensor: retrieving a respective predefined correlation between positions of pixels in the respective subset and positions in a subframe corresponding to the respective subset based on an identification of the respective subset; extracting pixel values of pixels of the respective subset and storing the extracted pixel values in positions of the corresponding subframe according to the predefined respective correlation; transmitting the subframe corresponding to the respective subset and the identification of the respective subset when the extracted pixel values are stored in the corresponding subframe, irrespective of a transmission timing of any of subframes corresponding to other subsets of the group; wherein the number of the different subsets in the group is equal to or larger than 2; a respective number of pixels in each subset of the group is smaller than a number of the pixels of the image sensor.

According to a second aspect of the invention, there is provided an apparatus, comprising at least one processor, at least one memory including computer program code, and the at least one processor, with the at least one memory and the computer program code, being arranged to cause the apparatus to at least perform, for each subset of a predefined group of subsets of pixels of an image sensor: extracting pixel values of pixels of the respective subset and storing the extracted pixel values in positions of a corresponding subframe according to a predefined respective correlation between positions in the corresponding subframe and positions of the pixels of the respective subset in the image sensor; transmitting the corresponding subframe separately from a subframe corresponding to another subset of the group of subsets; wherein a respective number of pixels in each of the subsets of the group of subsets is smaller than a number of pixels in the image sensor; the pixels are arranged in the image sensor in rows and columns; the group of subsets comprises a first subset and a second subset different from the first subset; the first subset comprises a first pixel belonging to one row of the rows; the second subset comprises a second pixel belonging to the one row of the rows; the group of subsets comprises a third subset and a fourth subset different from the third subset; the third subset comprises a third pixel belonging to one column of the columns; and the fourth subset comprises a fourth pixel belonging to the one column of the columns.

According to a third aspect of the invention, there is provided an apparatus, comprising at least one processor, at least one memory including computer program code, and the at least one processor, with the at least one memory and the computer program code, being arranged to cause the apparatus to at least perform, for each subset of a predefined group of subsets of pixels of an image sensor: retrieving a respective predefined correlation between positions of pixels in the respective subset and positions in a subframe corresponding to the respective subset based on an identification of the respective subset; extracting pixel values of pixels of the respective subset and storing the extracted pixel values in positions of the corresponding subframe according to the predefined respective correlation; checking if a similarity of the subframe corresponding to the respective subset with a previously transmitted subframe corresponding to the respective subset is larger than a predefined threshold; inhibiting transmitting the subframe corresponding to the respective subset and the identification of the respective subset if the similarity is larger than the threshold; wherein the number of the different subsets in the group is equal to or larger than 2; a respective number of pixels in each subset of the group is smaller than a number of the pixels of the image sensor.

According to a fourth aspect of the invention, there is provided an apparatus, comprising at least one processor, at least one memory including computer program code, and the at least one processor, with the at least one memory and the computer program code, being arranged to cause the apparatus to at least perform, for each subset of a predefined group of subsets of a set of memory cells: monitoring if a subframe together with an identification of the respective subset is received, irrespective of a reception timing of any other subframe; retrieving, if the subframe and the identification are received, a respective predefined correlation between positions in the subframe and positions of the memory cells of the respective subset based on the identification of the respective subset; updating pixel values of the pixels of the respective subset by pixel values of the subframe, wherein the positions of the memory cells of the respective subset in the set of memory cells correspond to the positions in the subframe according to the correlation; a number of the subsets in the predefined group is equal to or larger than 2; a respective number of the memory cells in each of the subsets is smaller than a number of the memory cells in the set; each of the memory cells of the set corresponds unambiguously to a respective pixel of an image display device.

According to a fifth aspect of the invention, there is provided an apparatus, comprising at least one processor, at least one memory including computer program code, and the at least one processor, with the at least one memory and the computer program code, being arranged to cause the apparatus to at least perform, for each subset of a predefined group of subsets of a set of memory cells: updating pixel values of the memory cells of the respective subset by pixel values of a received subframe corresponding to the subset according to a predefined respective correlation of positions in the corresponding subframe and positions of the memory cells of the set; each of the memory cells of the set corresponds unambiguously to a respective pixel of an image display device; a number of memory cells in each of the subsets is smaller than a number of pixels in the image display device; the pixels of the image display device are arranged in columns and rows; the group of subsets comprises a first subset and a second subset different from the first subset; the first subset comprises a memory cell corresponding to a first pixel belonging to one row of the rows of the pixels in the image display device; the second subset comprises a memory cell corresponding to a second pixel belonging to the one row of the rows of the pixels in the image display device; the group of subsets comprises a third subset and a fourth subset different from the third subset; the third subset comprises a memory cell corresponding to a third pixel belonging to one column of the columns of the pixels in the image display device; and the fourth subset comprises a memory cell corresponding to a fourth pixel belonging to the one column of the columns of the pixels in the image display device.

According to a sixth aspect of the invention, there is provided an apparatus, comprising at least one processor, at least one memory including computer program code, wherein subsets of a predefined group of subsets of a set of memory cells are ordered in an ordered sequence; a number of the subsets in the predefined group is equal to or larger than 2; a respective number of the memory cells in each of the subsets is smaller than a number of the memory cells in the set; each of the memory cells of the set corresponds unambiguously to a respective pixel of an image display device; and the at least one processor, with the at least one memory and the computer program code, being arranged to cause the apparatus to at least perform, for each subset of the predefined group: monitoring if, in the ordered sequence of subsets, a received subframe is received together with an identification of the respective subset at a slot corresponding to a position of the respective subset in the ordered sequence; maintaining pixel values of the pixels of the respective subset if the received subframe is not received together with the identification of the respective subset at the slot corresponding to the position of the respective subset in the ordered sequence.

According to a seventh aspect of the invention, there is provided a method, comprising, for each subset of a predefined group of subsets of pixels of an image sensor: retrieving a respective predefined correlation between positions of pixels in the respective subset and positions in a subframe corresponding to the respective subset based on an identification of the respective subset; extracting pixel values of pixels of the respective subset and storing the extracted pixel values in positions of the corresponding subframe according to the predefined respective correlation; transmitting the subframe corresponding to the respective subset and the identification of the respective subset when the extracted pixel values are stored in the corresponding subframe, irrespective of a transmission timing of any of subframes corresponding to other subsets of the group; wherein the number of the different subsets in the group is equal to or larger than 2; a respective number of pixels in each subset of the group is smaller than a number of the pixels of the image sensor.

According to an eighth aspect of the invention, there is provided a method, comprising, for each subset of a predefined group of subsets of pixels of an image sensor: extracting pixel values of pixels of the respective subset and storing the extracted pixel values in positions of a corresponding subframe according to a predefined respective correlation between positions in the corresponding subframe and positions of the pixels of the respective subset in the image sensor; transmitting the corresponding subframe separately from a subframe corresponding to another subset of the group of subsets; wherein a respective number of pixels in each of the subsets of the group of subsets is smaller than a number of pixels in the image sensor; the pixels are arranged in the image sensor in rows and columns; the group of subsets comprises a first subset and a second subset different from the first subset; the first subset comprises a first pixel belonging to one row of the rows; the second subset comprises a second pixel belonging to the one row of the rows; the group of subsets comprises a third subset and a fourth subset different from the third subset; the third subset comprises a third pixel belonging to one column of the columns; and the fourth subset comprises a fourth pixel belonging to the one column of the columns.

According to a ninth aspect of the invention, there is provided a method, comprising: retrieving a respective predefined correlation between positions of pixels in the respective subset and positions in a subframe corresponding to the respective subset based on an identification of the respective subset; extracting pixel values of pixels of the respective subset and storing the extracted pixel values in positions of the corresponding subframe according to the predefined respective correlation; checking if a similarity of the subframe corresponding to the respective subset with a previously transmitted subframe corresponding to the respective subset is larger than a predefined threshold; inhibiting transmitting the subframe corresponding to the respective subset and the identification of the respective subset if the similarity is larger than the threshold; wherein the number of the different subsets in the group is equal to or larger than 2; a respective number of pixels in each subset of the group is smaller than a number of the pixels of the image sensor.

According to a tenth aspect of the invention, there is provided a method, comprising, for each subset of a predefined group of subsets of a set of memory cells: monitoring if a subframe together with an identification of the respective subset is received, irrespective of a reception timing of any other subframe; retrieving, if the subframe and the identification are received, a respective predefined correlation between positions in the subframe and positions of the memory cells of the respective subset based on the identification of the respective subset; updating pixel values of the pixels of the respective subset by pixel values of the subframe, wherein the positions of the memory cells of the respective subset in the set of memory cells correspond to the positions in the subframe according to the correlation; a number of the subsets in the predefined group is equal to or larger than 2; a respective number of the memory cells in each of the subsets is smaller than a number of the memory cells in the set; each of the memory cells of the set corresponds unambiguously to a respective pixel of an image display device.

According to an eleventh aspect of the invention, there is provided a method, comprising, for each subset of a predefined group of subsets of a set of memory cells: updating pixel values of the memory cells of the respective subset by pixel values of a received subframe corresponding to the subset according to a predefined respective correlation of positions in the corresponding subframe and positions of the memory cells of the set; each of the memory cells of the set corresponds unambiguously to a respective pixel of an image display device; a number of memory cells in each of the subsets is smaller than a number of pixels in the image display device; the pixels of the image display device are arranged in columns and rows; the group of subsets comprises a first subset and a second subset different from the first subset; the first subset comprises a memory cell corresponding to a first pixel belonging to one row of the rows of the pixels in the image display device; the second subset comprises a memory cell corresponding to a second pixel belonging to the one row of the rows of the pixels in the image display device; the group of subsets comprises a third subset and a fourth subset different from the third subset; the third subset comprises a memory cell corresponding to a third pixel belonging to one column of the columns of the pixels in the image display device; and the fourth subset comprises a memory cell corresponding to a fourth pixel belonging to the one column of the columns of the pixels in the image display device.

According to a twelfth aspect of the invention, there is provided a method, wherein subsets of a predefined group of subsets of a set of memory cells are ordered in an ordered sequence; a number of the subsets in the predefined group is equal to or larger than 2; a respective number of the memory cells in each of the subsets is smaller than a number of the memory cells in the set; each of the memory cells of the set corresponds unambiguously to a respective pixel of an image display device; and the method comprises: monitoring if, in the ordered sequence of subsets, a received subframe is received together with an identification of the respective subset at a slot corresponding to a position of the respective subset in the ordered sequence; maintaining pixel values of the pixels of the respective subset if the received subframe is not received together with the identification of the respective subset at the slot corresponding to the position of the respective subset in the ordered sequence.

Each of the methods of the seventh to ninth aspects may be a method of video transmission. Each of the methods of the tenth to twelfth aspects may be a method of video reception.

According to a thirteenth aspect of the invention, there is provided a computer program product comprising a set of instructions which, when executed on an apparatus, is configured to cause the apparatus to carry out the method according to any of the seventh to twelfth aspects. The computer program product may be embodied as a computer-readable medium or directly loadable into a computer.

Further details are set out in the respective dependent claims.

According to some embodiments of the invention, at least one of the following advantages may be achieved:
Real time video transmission is improved;
Data flow over the transmission line is smoothed;
Amount of transmitted data is reduced;

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a conventional video transmission system;

FIG. 2 shows a video transmission system according to some embodiments of the invention;

FIG. 3 shows the application of different fractional schemes on a n image;

FIG. 4 shows a message sequence chart according to some embodiments of the invention;

FIG. 5 shows an algorithm of the sieve stack scheme according to some embodiments of the invention;

FIG. 6 shows a pixel matrix and its division into subsets of the sieve stack scheme according to some embodiments of the invention;

FIG. 7 illustrates the application of the sieve stack scheme on an image on the receiver side according to some embodiments of the invention;

FIG. 8 shows a transmission using the sieve stack scheme according to some embodiments of the invention;

FIG. 9 shows a message sequence chart with an included algorithm of the sieve stack scheme according to some embodiments of the invention;

FIG. 10 illustrates the application of the sieve stack scheme with n=2 on an image on the receiver side according to some embodiments of the invention;

FIG. 11 illustrates the application of the sieve stack scheme with n=3 on an image on the receiver side according to some embodiments of the invention;

FIG. 12 shows an apparatus according to an embodiment of the invention;

FIG. 13 shows a method according to an embodiment of the invention;

FIG. 14 shows an apparatus according to an embodiment of the invention;

FIG. 15 shows a method according to an embodiment of the invention;

FIG. 16 shows an apparatus according to an embodiment of the invention;

FIG. 17 shows a method according to an embodiment of the invention;

FIG. 18 shows an apparatus according to an embodiment of the invention;

FIG. 19 shows a method according to an embodiment of the invention;

FIG. 20 shows an apparatus according to an embodiment of the invention;

FIG. 21 shows a method according to an embodiment of the invention;

FIG. 22 shows an apparatus according to an embodiment of the invention;

FIG. 23 shows a method according to an embodiment of the invention; and

FIG. 24 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Some embodiments of the invention provide an apparatus that allows to provide video information coping with almost any given latency requirement. Some embodiments of the invention provide a coding algorithm that is particularly suitable for real-time video. For example, the algorithm may be applied to the above mentioned apparatus to allow for premium quality videos in real time.

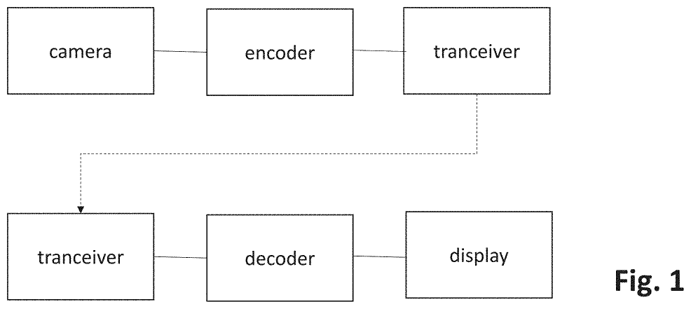

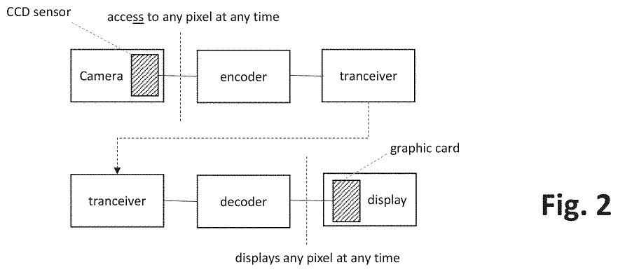

While FIG. 1 shows a traditional digital camera which delivers full frame pictures at a given rate (frames per second), some embodiments of this invention use another mode for transmitting video information in a more real time manner, as shown in FIG. 2. Here a camera module (fractional camera) at the sending peer comprises a CCD sensor which is able to capture visual information in real time and which exposes this information in an x/y matrix (rows and columns) of pixels. But instead of compiling full video frames and handing those over for further processing to an encoder at a given frame rate, the camera module allows access to any of the pixels at any time.

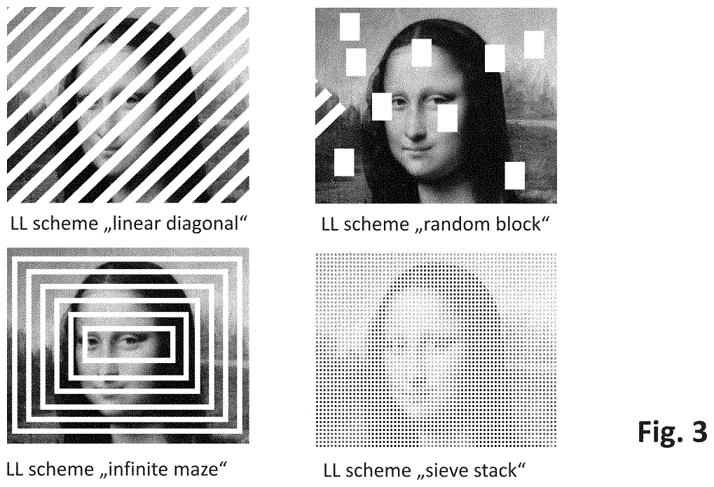

Preferably, there are pre-defined schemes (see e.g. FIG. 3 below) that pass over fractions of the x/y pixel matrix (i.e. subsets of pixels) to an encoder, embodied e.g. as a computing node. In principle, transmission from the camera module to the encoder may happen even on a per pixel base.

At the other end of a video transmission (receiving peer), the transmitted information (which in the simplest case could be one pixel) will be passed over from the decoder to a display module (e.g. a graphic card) as it is received. I.e. there is no need to adapt the display to a give frame rate.

Of course, transmission of one pixel only might not be very convenient or helpful, rather subsets of pixels following a given scheme (also named fractional scheme) will be accessed from the fractional camera. FIG. 3 shows some possible fractional schemes that allow fractional delivery of video information.

For example, an image can be divided into horizontal, vertical or diagonal lines (FIG. 3, top left). Each of the subsets may comprise one or more of these lines. Depending on the desired granularity and the given real time requirements, two or more sub-frames may be sent to transmit each pixel of the image sensor at least once. Another way to divide an image into subsets of pixel is (pseudo-)randomly dividing the image into blocks of pixels and to transmit the blocks (subsets) of pixels (FIG. 3, top right). Furthermore, subsets of pixels could be generated as a maze (FIG. 3, bottom left). There are almost infinite ways how to structure subsets of pixels out of an image, all of them having technical pros and cons and customer perception advantages and drawbacks.

There is one fractional scheme (sieve stack: an example is shown in FIG. 3, bottom right) which limits the drawbacks and offers almost infinite scaling capabilities. This scheme is discussed below at greater detail.

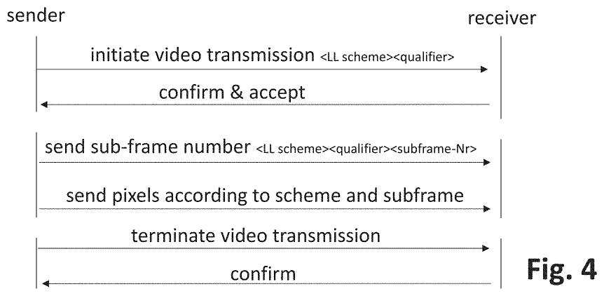

A video transmission will be started by negotiating or by assigning a fractional scheme that shall be used during a video transmission. FIG. 4 shows an according message sequence chart.

The sender initiates the video transmission by sending information about the fractional scheme to be used [LL scheme]. The information may also include a qualifier. The qualifier will explicitly or implicitly indicate how many sub frames shall be used (see below).

In a mutual dialog the receiver will confirm these settings or reject (in case it does not support the scheme). During video transmission the sender will send according subframes following the scheme. In addition, the sender may send an according subframe number.

In a simple example, the image is divided into horizontal (or vertical) lines, and the scheme shall comprise of 4 sub frames. In this case the qualifier is n=4. If an image comprises 1000 lines (I=0 to 999), the first subframe comprises all lines that follow the equation i mod 4=0, the second subframe comprises all lines following the equation (i+1 mod 4)=0 and so forth. When the subframes are received (alongside with the subframe number), the receiver may update the canvas/graphic card by only replacing the pixels corresponding to the received subframe. Thus, not the complete image will be updated in the canvas/graphic card, but only the fraction (subset) corresponding to the received subframe.

The transmission may be performed in one of two modes:

Sync mode: in this mode the subframes will be sent according to a given full frame rate. A “normal” full frame transmission (measured in frames per second fps) will be further divided into sub frames. That is, each of the subframes is transmitted in a respective slot.

Example: a video transmission of 25 fps means that each frame is received 40 ms after the previous frame—leading to an inherent video delay of 40 ms. If the image is divided into 5 subsets, and each corresponding subframe is sent after 25/5 ms, the full image is transmitted within the given full frame rate (25 fps). However, the inherent delay between sub frames would be limited to at least 5 ms.

Free Floating mode: In this mode the camera will send the subframes at any speed. That is, each subframe may be sent when it is completely filled by the pixel values of the corresponding subset of the pixels of the image. The timing of the transmission of each subframe is independent from the timing of the transmission of all the other subframes. Thus, the time difference between the subframes may be as low as hardware and network connection (bandwidth, jitter) allow.

In order to enable the receiving side to correctly assign the received subframes to subsets of the pixels of the graphic card/canvas (a set of memory cells), each subframe is accompanied by an identification of the subset of pixels of the image on which the pixel values transmitted in the subframe are based. This identification also indictes a correlation between the positions of the pixel values in the subframe and the position of the corresponding pixels in the subset of pixels in the image. The positions of the pixels in the image should typically correspond to the positions of the memory cells in the set of memory cells (potentially with some scaling in between).

If the receiving side is not able to process and/or display the data as fast as the sender delivers, some of the subframes may simply be dropped.

As mentioned above, the fractional scheme “sieve” is particularly suitable for real time video transmission. This fractional scheme uses grids of a pixel matrix to achieve “nested” sub frames. FIG. 6 shows the basic idea as an algorithm. The algorithm may be expressed as follows:

The pixels of the image sensor are arranged in rows and columns; each of the subsets comprises, out of every xth row of the pixels of the image sensor starting from the zth row of the rows of the pixels of the image sensor, every w^{th} pixel of the respective row starting from the yth pixel of the respective row; each of the subsets corresponds to a respective pair of y and z different from the respective pair of y and z of each of the other subsets; 1<w<y, 1<x<z; and y and z are natural numbers equal to or larger than 2.

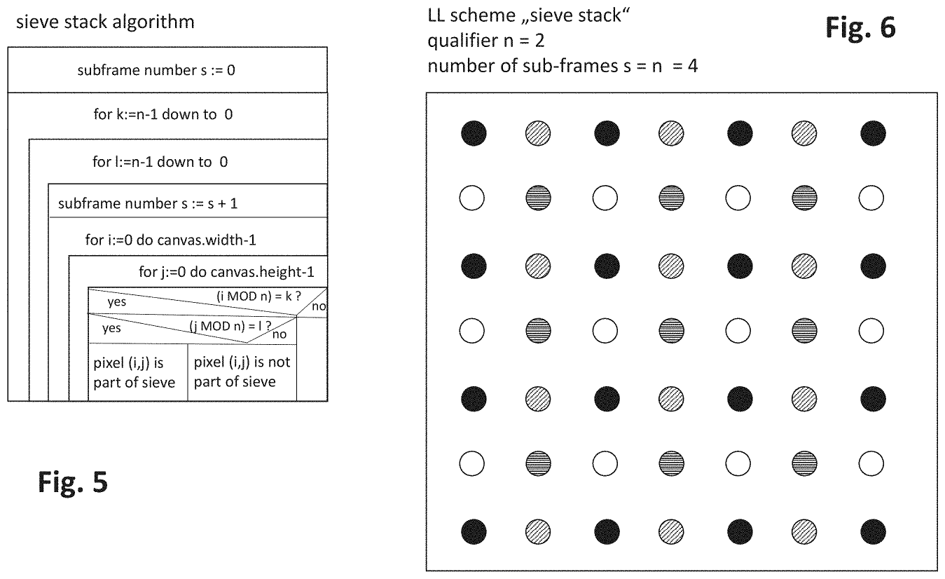

This is illustrated by a 7×7 pixel matrix shown in FIG. 6. This image with the resolution of 7×7 is divided into 4 sub frames, each sub frame represented by differently filled pixels. The qualifier n that is related to this codec will result in n*n sub frames (since n is effective in horizontal and vertical direction; in general, same or different values may be effective in horizontal and vertical directions). The algorithm of how to determine which of the pixels belong to which of the subframes is shown in FIG. 5.

Namely, there are two nested loops (loop variable k and n) that run from n−1 down to 0. At each loop step the frame counter s is increased (leading to n*n sub frames). Within each loop step (or sub frame, respectively) there are again two nested loops (variable i and j) that run over the horizontal and vertical pixel lengths of the pixel matrix (0 to canvas[image].width-1 and 0 to canvas[image].height-1). Whether or not a pixel belongs to a sub frame will be determined by the fulfilment of the two equations “(i MOD n)=k” and “j MOD n=I”. Please note that different sub frames may include different numbers of pixels.

An identification of each of the subsets may correspond to the pair of k and l of the respective subset. For example, the identification may be the pair of k and l, or the pairs of k and l of the subsets may be mapped unambiguously to another identifier. E.g.:

(1, 1)→1

(2, 1)→2

(k, 1)→k

(1, 2)→k+1

(2, 2)→k+2 etc.

(k, l)→k*l.

The geometrical meaning of the sieve (with n=2) is shown in FIG. 6. Pixels belonging to the same subset of pixels have a respective same filling of the dots.

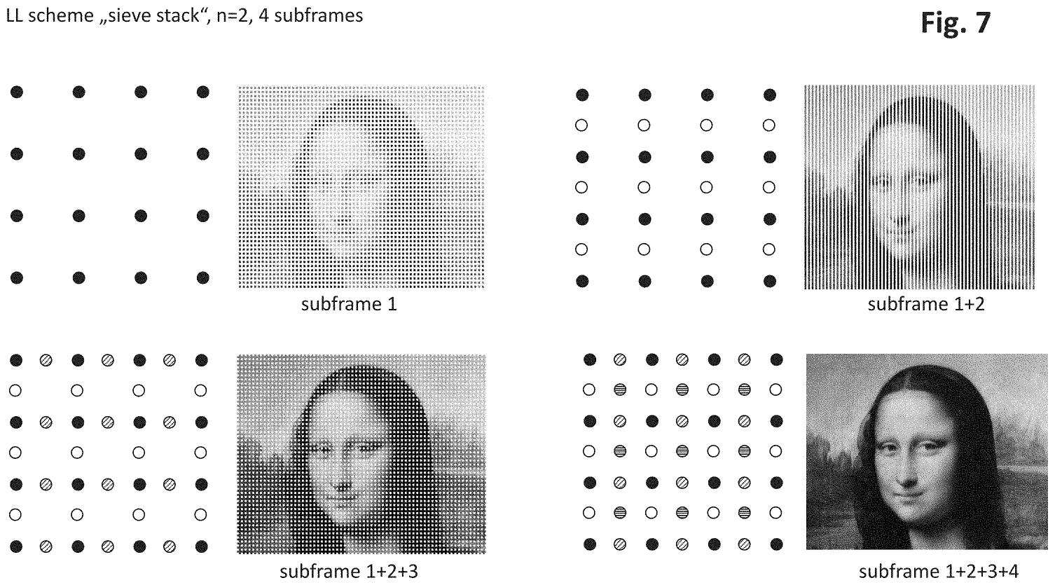

FIG. 7 shows an example for a sieve stack qualifier n=2 (4 sub frames) applied to an image. FIG. 7 shows the composition of the image by subsequently adding the subsets corresponding to received subframes. Each of the single subsets does not have a big difference to the other subsets since those are only a pixel apart from each other.

In real time video streaming, only those pixels of the image that belong to a subset for which the corresponding subframe is received are replaced in the image.

Since the fractional camera allows to transmit only parts of an image, the delay between reading a subset of pixels of an image on the sensor and receiving the corresponding subframe at the receiver may be the pure transmission delay. The sieve stack algorithm provides additional advantages to other fractional schemes:
any sub frame contains information about the overall picture (see FIG. 7: an image is always displayed in full);
it further allows to eliminate issues that are known from state-of-the-art partialized video codices:
   block artefacts as known from e.g. MPEG compression schemes arising when block wise coding occurs
   comb-artefacts as known from PAL when line wise encoding occurs
it allows a very flexible usage, the number of subsets may range from four up to the dimension of the pixel matrix
it is very easy to implement on both sides (encoder/decoder)
it allows to apply further compression on individual sub frames;
it is very failure-tolerant, i.e., if sub frames will be missing, the full image can easily be rendered up.

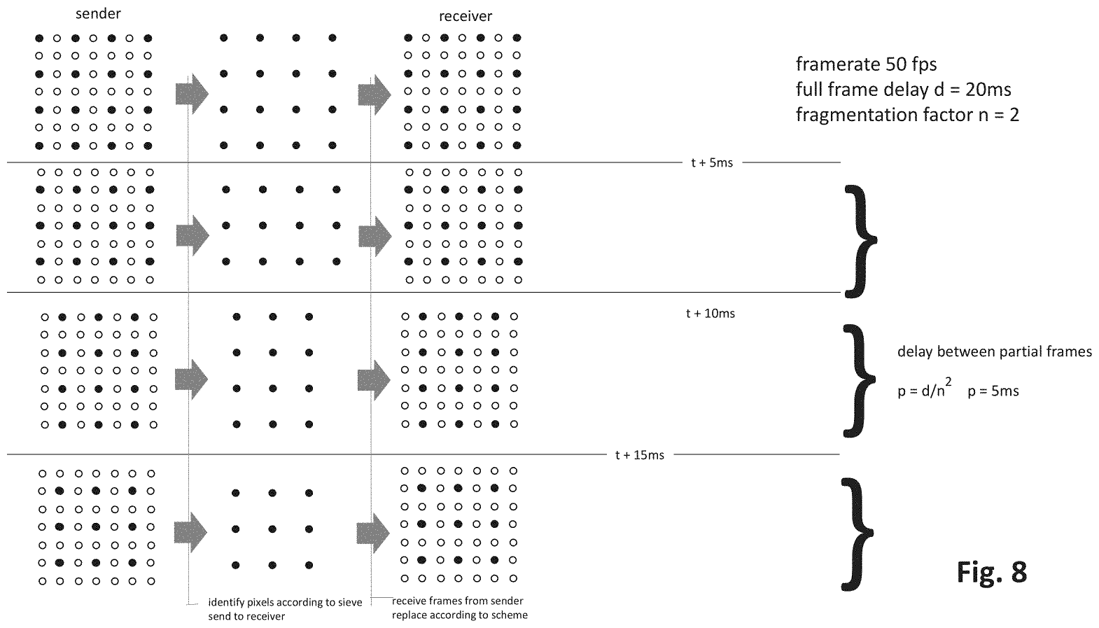

FIG. 8 shows an implementation of the sieve stack scheme with a qualifier (fragmentation factor) n=2 leading to 4 sub frames. Given a full framerate of 50 fps each frame would reach 20 ms later than the previous frame leading to an inherent video delay of 20 ms. With the given division into 4 subframes each of the subframes will reach the receiver only 5 ms after the previous frame leading to an inherent video delay of 5 ms. In the figure, the pixels belonging to the respective subset of which the corresponding subframe is to be transmitted are shown by black dots, whereas the other pixels are shown as white dots.

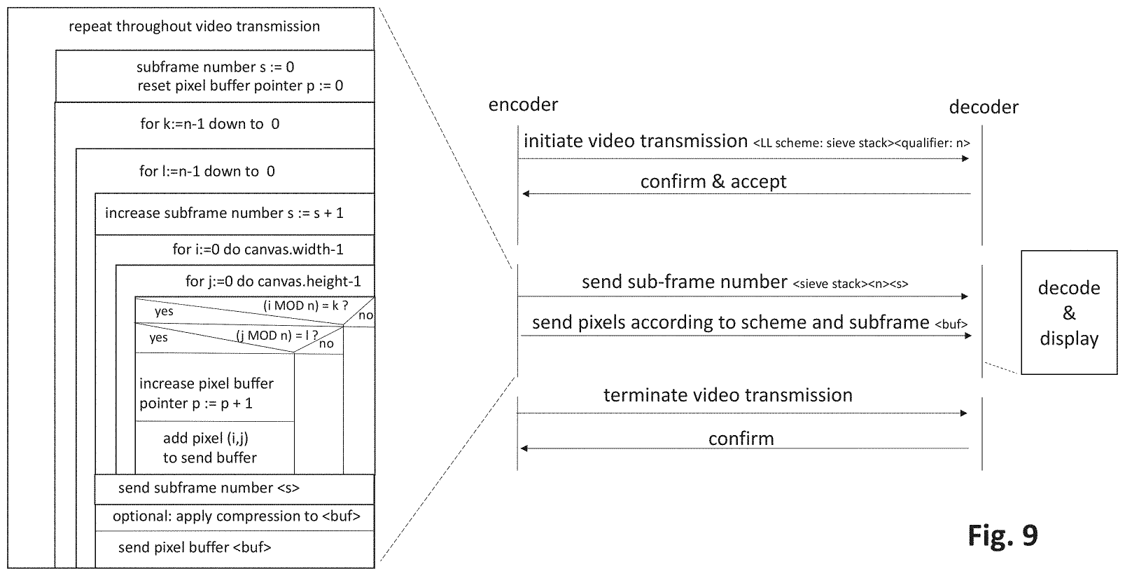

FIG. 9 shows the implementation of the sieve stack algorithm as described hereinabove for the encoder. In addition to FIG. 5, this encoder works in a continuous loop as long as the video stream is existing. Furthermore, since the transmission is performed in the Sync mode in this implementation example, the pixel data (pixel values) of a subframe shall be stored in a pixel buffer. A simple implementation of this buffer would be a pixel array (byte, integer, . . . ) organized as array of records with each record representing pixel data matching a given colour resolution (16 bit, 24 bit, 32 bit, . . . ). Each pixel data will be added to the buffer as it is identified as being relevant according to the algorithm by increasing the pixel buffer pointer.

After each run through the image loop (i/j—loops in example) the buffer data is sent to the receiver together with the sub frame number which allows the receiver to place the pixels at appropriate places on a canvas/graphic card. Beneficially, before sending the subframe, the buffer data may be further compressed. The compression may be a per-frame-compression, i.e., in order to maintain the real time requirements, a compression is not suitable which is taking care of the moving of objects in a scene, as e.g. is used for MPEG compression. This sort of compression (since it uses data of various previous frames) would, due to its interleaving character, add further delay to the inherent video delay. Compression schemes applicable to the buffer data are e.g. loss-less run-length encodings (PCX) or lossful JPEG (JPG).

On the receiving side, a decoder may run based on a corresponding algorithm. The received buffer data will be processed, i.e. each pixel will be read out of the buffer and the pixel buffer pointer will be increased. The position of the pixels on the receiver's canvas is pre-defined by the fractional scheme (sieve stack), the qualifier n, the sub frame number and the position of the pixel buffer pointer. Note if the pixel resolution of the camera CCD and the canvas/graphic card to not match, additional scaling up/down may be applied on the receiving side or already on the sending side.

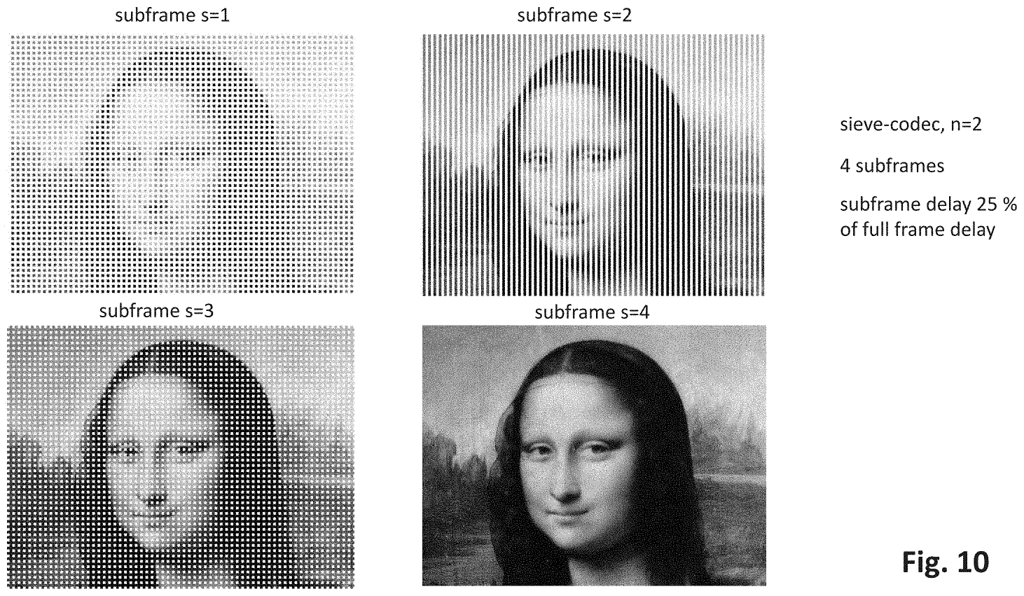

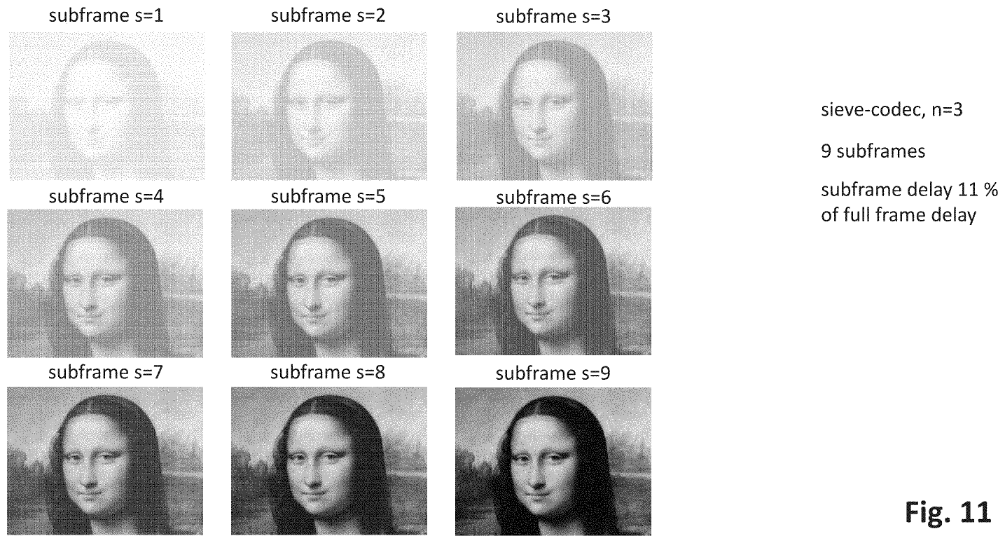

The effect is shown in FIG. 10 (for n=2, 4 subframes) and FIG. 11 (for n=3, 9 subframes). These figures show how the image at the receiver is built up by successively receiving the corresponding subframes. As may be seen, starting from the first subframe, the image is well recognizable, although this first subframe has a delay of only 25% (11%) of a full frame delay. When the other subframes are received, more details of the image become recognizable.

While the above implementation was explained for transmission in the Sync mode, the transmission may be performed in the Free Floating mode instead. In this case, the delay may be even shorter because the sender sends each subframe as soon as it is filled with the pixel values of the corresponding subset. The receiver may identify the subframes and corresponding subsets based on the identifier of the subset which is transmitted along with the corresponding subframe.

In some embodiments of the invention, the sender may check, before it transmits a subframe, if the subframe to be transmitted is very similar to the corresponding previous subframe (i.e. to the previous subframe corresponding to the same subset of pixels.) “Very similar” could mean e.g. that a sum of squares (or absolute values) of differences of pixel values between the current subframe and the previous subframe is less than a predefined threshold. In this case, the sender may not transmit the subframe at all.

Since the receiver does not receive the subframe in this case, it maintains the present subset of pixels, which is very similar to the current subset of pixels. Furthermore, from the identification received along with the next subframe, the receiver knows that the next subframe corresponds to another subset of pixels than expected according to a predefined ordered sequence of the subsets (if such predefined ordered sequence exists). Thus, the receiver can correctly assign the received subframe to another subset of the pixels. If the predefined ordered sequence exists, the receiver may then assume that the next received subframe corresponds to the next subset following the one for which the current subframe was received.

In some embodiments, if the ordered sequence of pixels exists, the receiver may check if the number of missing subframes is higher than a threshold. In this case, the receiver may assume that the maintained image is not appropriate anymore because the objects in the image might have moved considerably. Therefore, in this case, the receiver may not maintain the pixels of the other subsets but may generate a new image by rendering the pixel values of the other subsets from the pixel values of the received subframe.

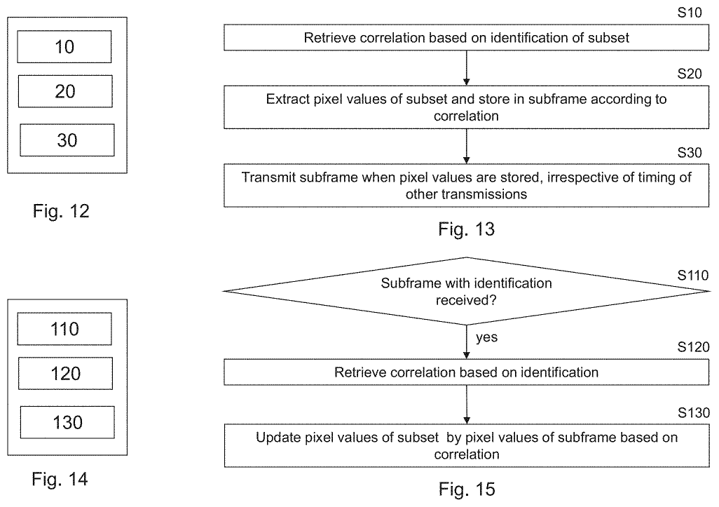

FIG. 12 shows an apparatus according to an embodiment of the invention. The apparatus may be a camera such as a fractional camera or an element thereof. FIG. 13 shows a method according to an embodiment of the invention. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises retrieving means 10, extracting means 20, and transmitting means 30. Each of the retrieving means 10, extracting means 20, and transmitting means 30 may be a retrieving processor, extracting processor, and transmitting processor, respectively.

The following activities are performed for each subset of a predefine group of subsets of pixels of an image sensor. The number of the different subsets in the group is equal to or larger than 2. A respective number of pixels in each subset of the group is smaller than a number of the pixels of the image sensor.

The retrieving means 10 retrieves a respective predefined correlation between positions of pixels in the respective subset and positions in a subframe based on an identification of the respective subset (S10). The subframe corresponds to the respective subset.

The extracting means 20 extracts pixel values of pixels of the respective subset and stores the extracted pixel values in positions of the corresponding subframe according to the predefined respective correlation (S20). The correlation is retrieved by the retrieving means 10 in S10.

The transmitting means 30 transmits the subframe corresponding to the respective subset and the identification of the respective subset when the extracted pixel values are stored in the corresponding subframe (S30). The subframe is transmitted irrespective of a transmission timing of any of subframes corresponding to other subsets of the group. That is, the transmission follows the Free Floating mode described hereinabove.

FIG. 14 shows an apparatus according to an embodiment of the invention. The apparatus may be an image display device such as a beamer or a canvas or an element thereof such as a graphic card. FIG. 15 shows a method according to an embodiment of the invention. The apparatus according to FIG. 14 may perform the method of FIG. 15 but is not limited to this method. The method of FIG. 15 may be performed by the apparatus of FIG. 14 but is not limited to being performed by this apparatus.

The apparatus comprises monitoring means 110, retrieving means 120, and updating means 130. Each of the monitoring means 110, retrieving means 120, and updating means 130 may be a monitoring processor, retrieving processor, and updating processor, respectively.

The following activities are performed for each subset of a predefined group of subsets of pixels of a set of memory cells. The number of the different subsets in the group is equal to or larger than 2. A respective number of memory cells in each subset of the group is smaller than a number of the memory cells in the set. Each of the memory cells of the set corresponds unambiguously to a respective pixel of the image display device.

The monitoring means 110 monitors if a subframe together with an identification of the respective subset is received (S110). The monitoring is performed irrespective of a reception timing of any other subframe.

If the subframe and the identification are received (S110=“yes”), the retrieving means 120 retrieves a respective predefined correlation between positions in the subframe and positions of the memory cells of the respective subset (S120). The correlation is retrieved based on the identification of the respective subset.

The updating means 130 updates pixel values of the pixels of the respective subset by pixel values of the subframe (S130). The positions of the memory cells of the respective subset in the set of memory cells correspond to the positions in the subframe according to the retrieved correlation.

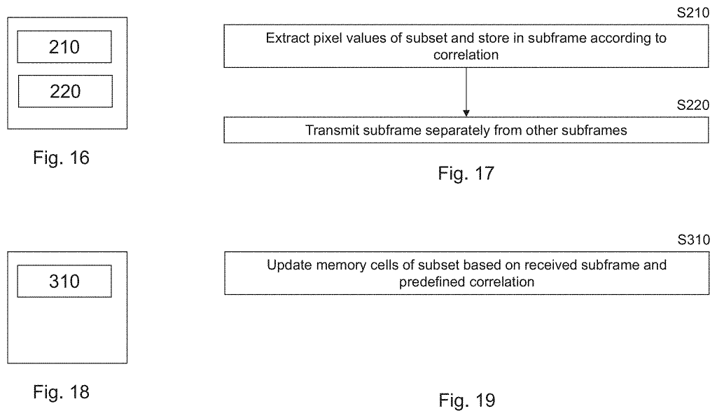

FIG. 16 shows an apparatus according to an embodiment of the invention. The apparatus may be a camera such as a fractional camera or an element thereof. FIG. 17 shows a method according to an embodiment of the invention. The apparatus according to FIG. 16 may perform the method of FIG. 17 but is not limited to this method. The method of FIG. 17 may be performed by the apparatus of FIG. 16 but is not limited to being performed by this apparatus.

The apparatus comprises extracting means 210, and transmitting means 220. Each of the extracting means 210 and transmitting means 220 may be an extracting processor and transmitting processor, respectively.

The following activities are performed for each subset of a predefined group of subsets of pixels of an image sensor. A respective number of pixels in each subset of the group is smaller than a number of the pixels of the image sensor. The pixels are arranged in the image sensor in rows and columns.

The group of subsets comprises a first subset and a second subset different from the first subset; the first subset comprises a first pixel belonging to one row of the rows; the second subset comprises a second pixel belonging to the one row of the rows. I.e., both the first and the second subsets have one pixel of the same row.

The group of subsets comprises a third subset and a fourth subset different from the third subset; the third subset comprises a third pixel belonging to one column of the columns; and the fourth subset comprises a fourth pixel belonging to the one column of the columns. I.e., both the third and the fourth subsets have one pixel of the same column.

The first subset may be one of the third and fourth subsets or different from both of them. The second subset may be one of the third and fourth subsets or different from both of them.

The extracting means 210 extracts pixel values of pixels of the respective subset and stores the extracted pixel values in positions of a corresponding subframe according to a predefined respective correlation for the subset (S210). The correlation correlates positions in the corresponding subframe and positions of the pixels of the respective subset in the image sensor.

The correlation schemes for the retrieving means 10 and for the receiving means 210 may be different e.g. to cope with different resolutions of a camera and of a display.

The transmitting means 220 transmits the corresponding subframe separately from a subframe corresponding to another subset of the group of subsets (S220)

FIG. 18 shows an apparatus according to an embodiment of the invention. The apparatus may be an image display device such as a beamer or a canvas or an element thereof such as a graphic card, FIG. 19 shows a method according to an embodiment of the invention. The apparatus according to FIG. 18 may perform the method of FIG. 19 but is not limited to this method. The method of FIG. 19 may be performed by the apparatus of FIG. 18 but is not limited to being performed by this apparatus.

The apparatus comprises updating means 310. The updating means 310 may be an updating processor.

The following activities are performed for each subset of a predefined group of subsets of a set of memory cells. A respective number of memory cells in each subset of the group is smaller than a number of the memory cells in the set. Each of the memory cells of the set corresponds unambiguously to a respective pixel of the image display device. The pixels of the image display device are arranged in columns and rows.

The group of subsets comprises a first subset and a second subset different from the first subset. The first subset comprises a memory cell corresponding to a first pixel belonging to one row of the rows of the pixels in the image display device. The second subset comprises a memory cell corresponding to a second pixel belonging to the one row of the rows of the pixels in the image display device. That is, the first subset and the second subset comprise a respective memory cell belonging to a same row of the pixels of the image display device.

The group of subsets comprises a third subset and a fourth subset different from the third subset. The third subset comprises a memory cell corresponding to a third pixel belonging to one column of the columns of the pixels in the image display device. The fourth subset comprises a memory cell corresponding to a fourth pixel belonging to the one column of the columns of the pixels in the image display device. That is, the third subset and the fourth subset comprise a respective memory cell belonging to a same row of the pixels of the image display device.

The first subset may be one of the third and fourth subsets or different from both of them. The second subset may be one of the third and fourth subsets or different from both of them.

The updating means 310 updates pixel values of the memory cells of the respective subset by pixel values of a received subframe corresponding to the subset according to a predefined respective correlation of positions in the corresponding subframe and positions of the memory cells of the set (S310).

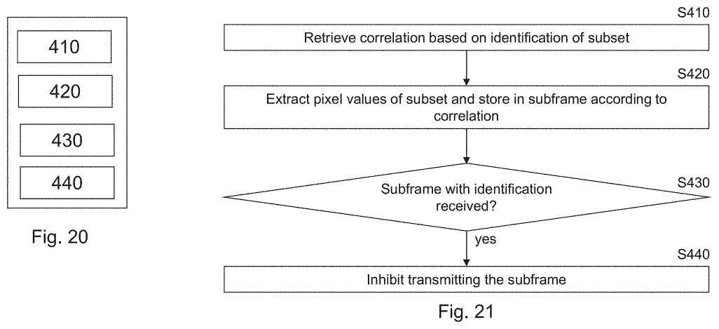

FIG. 20 shows an apparatus according to an embodiment of the invention. The apparatus may be a camera such as a fractional camera or an element thereof. FIG. 21 shows a method according to an embodiment of the invention. The apparatus according to FIG. 20 may perform the method of FIG. 21 but is not limited to this method. The method of FIG. 21 may be performed by the apparatus of FIG. 20 but is not limited to being performed by this apparatus.

The apparatus comprises retrieving means 410, extracting means 420, checking means 430, and inhibiting means 440. Each of the retrieving means 10, extracting means 20, checking means 430, and inhibiting means 440 may be a retrieving processor, extracting processor, checking processor, and inhibiting processor, respectively.

The following activities are performed for each subset of a predefine group of subsets of pixels of an image sensor. The number of the different subsets in the group is equal to or larger than 2. A respective number of pixels in each subset of the group is smaller than a number of the pixels of the image sensor.

The retrieving means 410 retrieves a respective predefined correlation between positions of pixels in the respective subset and positions in a subframe corresponding to the respective subset (S410). The correlation is retrieved based on an identification of the respective subset.

The extracting means 420 extracts pixel values of pixels of the respective subset and stores the extracted pixel values in positions of the corresponding subframe according to the predefined respective correlation (S420).

The checking means 430 checks if a similarity of the subframe corresponding to the respective subset with a previously transmitted subframe corresponding to the respective subset is larger than a predefined threshold (S430). The previously transmitted subframe may be the last transmitted subframe corresponding to the respective subset.

If the similarity is larger than the threshold (S430=“yes”), the inhibiting means 440 inhibits transmitting the subframe corresponding to the respective subset and the identification of the respective subset (S440).

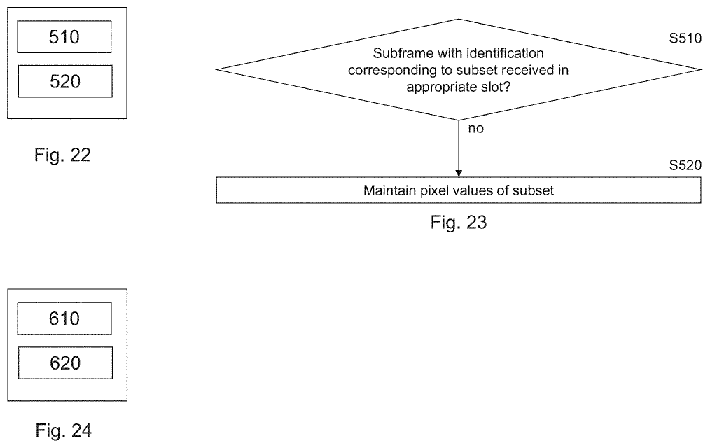

FIG. 22 shows an apparatus according to an embodiment of the invention. The apparatus may be an image display device such as a beamer or a canvas or an element thereof such as a graphic card. FIG. 23 shows a method according to an embodiment of the invention. The apparatus according to FIG. 22 may perform the method of FIG. 23 but is not limited to this method. The method of FIG. 23 may be performed by the apparatus of FIG. 22 but is not limited to being performed by this apparatus.

The apparatus comprises monitoring means 510 and maintaining means 520. Each of the monitoring means 510 and maintaining means 520 may be a monitoring processor and maintaining processor, respectively.

The following activities are performed for each subset of a predefined group of subsets of pixels of a set of memory cells. The number of the different subsets in the group is equal to or larger than 2. The subsets of the predefined group are ordered in an ordered sequence.

A respective number of memory cells in each subset of the group is smaller than a number of the memory cells in the set. Each of the memory cells of the set corresponds unambiguously to a respective pixel of the image display device.

The monitoring means 510 monitors if, in the ordered sequence of subsets, a received subframe is received together with an identification of the respective subset at a slot corresponding to a position of the respective subset in the ordered sequence (S510).

If the received subframe is not received together with the identification of the respective subset at the slot corresponding to the position of the respective subset in the ordered sequence (S510=“no”), the maintaining means 520 maintains pixel values of the pixels of the respective subset (S520).

FIG. 24 shows an apparatus according to an embodiment of the invention. The apparatus comprises at least one processor 610, at least one memory 620 including computer program code, and the at least one processor 610, with the at least one memory 620 and the computer program code, being arranged to cause the apparatus to at least perform at least one of the methods according to FIGS. 13, 15, 17, 19, 21, and 23.

One piece of information may be transmitted in one or plural messages from one entity to another entity. Each of these messages may comprise further (different) pieces of information.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

According to the above description, it should thus be apparent that example embodiments of the present invention provide, for example, an image recording and transmitting device such as a camera or a smartphone, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, an image display device such as a beamer or a screen, or a component thereof such as a graphic card, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments of the invention may be implemented in the cloud.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-94. (canceled)

95. An apparatus, comprising at least one processor, at least one memory including computer program code, and the at least one processor, with the at least one memory and the computer program code being arranged to cause the apparatus to at least perform, for each subset of a predefined group of subsets of pixels of an image sensor:
retrieving a respective predefined correlation between positions of pixels in the respective subset and positions in a subframe corresponding to the respective subset based on an identification of the respective subset;
extracting pixel values of pixels of the respective subset and storing the extracted pixel values in positions of the corresponding subframe according to the predefined respective correlation; and
transmitting the subframe corresponding to the respective subset and the identification of the respective subset when the extracted pixel values are stored in the corresponding subframe, irrespective of a transmission timing of any subframes corresponding to other subsets of the group, wherein
the number of different subsets in the group is equal to or larger than 2; and
a respective number of pixels in each subset of the group is smaller than a number of the pixels of the image sensor.

96. The apparatus according to claim 95, wherein each pixel of the image sensor is comprised in at least one of the subsets.

97. The apparatus according to claim 96, wherein each pixel of the image sensor is comprised in only one of the subsets.

98. The apparatus according to claim 97, wherein
the pixels of an image display device are arranged in rows and columns; and
each of the subsets comprises a diagonal line of the image sensor.

99. The apparatus according to claim 98, wherein the at least one processor, with the at least one memory and the computer program code, is arranged to cause the apparatus to further perform, for at least one of the subsets of the predefined group:
compressing the corresponding subframe after the pixel values of the respective subset are stored in the subframe, wherein
the transmitting comprises transmitting the compressed subframe.

100. An apparatus, comprising at least one processor, at least one memory including computer program code, and the at least one processor, with the at least one memory and the computer program code, being arranged to cause the apparatus to at least perform, for each subset of a predefined group of subsets of pixels of an image sensor:
retrieving a respective predefined correlation between positions of pixels in the respective subset and positions in a subframe corresponding to the respective subset based on an identification of the respective subset;
extracting pixel values of pixels of the respective subset and storing the extracted pixel values in positions of the corresponding subframe according to the predefined respective correlation;
checking if a similarity of the subframe corresponding to the respective subset with a previously transmitted subframe corresponding to the respective subset is larger than a predefined threshold; and
inhibiting transmitting the subframe corresponding to the respective subset and the identification of the respective subset if the similarity is larger than the threshold;
wherein:
the number of different subsets in the group is equal to or larger than 2; and
a respective number of pixels in each subset of the group is smaller than a number of the pixels of the image sensor.

101. The apparatus according to claim 100, wherein each pixel of the image sensor is comprised in at least one of the subsets.

102. The apparatus according to claim 101, wherein each pixel of the image sensor is comprised in only one of the subsets.

103. The apparatus according to claim 102, wherein:
the pixels of an image display device are arranged in rows and columns; and
each of the subsets comprises a diagonal line of the image sensor.

104. The apparatus according to claim 103, wherein the at least one processor, with the at least one memory and the computer program code, is arranged to cause the apparatus to further perform, for each of the subsets:
transmitting the subframe corresponding to the respective subset and the identification of the respective subset irrespective of a transmission timing of any of the subframes corresponding to the other subsets of the group.

105. The apparatus according to claim 104, wherein the subframe corresponding to the subset and the identification of the respective subset is transmitted immediately when the extracted pixel values are stored in the respective subframe and if the similarity is not larger than the threshold.

106. The apparatus according to claim 103, wherein
the subsets of the group are arranged in an order;
the subframes are transmitted in an ordered sequence; and
the at least one processor, with the at least one memory and the computer program code, is arranged to cause the apparatus to further perform, for each of the subsets:
transmitting the subframe corresponding to the respective subset and the identification of the respective subset at a slot in the ordered sequence corresponding to a position of the respective subset in the order if the similarity of the respective subset is less than the threshold; and
transmitting the subframe corresponding to a successor of the respective subset according to the order and the identification of the successor at the slot corresponding to the position of the respective subset in the order if the similarity of the respective subset is equal to or larger than the threshold and the similarity of the successor is less than the threshold.

107. The apparatus according to claim 106, wherein the at least one processor, with the at least one memory and the computer program code, is arranged to cause the apparatus to further perform, for at least one of the subsets of the predefined group:
compressing the corresponding subframe after the pixel values of the respective subset are stored in the subframe, wherein
the transmitting comprises transmitting the compressed subframe.

108. An apparatus, comprising at least one processor, at least one memory including computer program code, and the at least one processor, with the at least one memory and the computer program code, being arranged to cause the apparatus to at least perform, for each subset of a predefined group of subsets of a set of memory cells:
monitoring if a subframe together with an identification of the respective subset is received, irrespective of a reception timing of any other subframe;
retrieving, if the subframe and the identification are received, a respective predefined correlation between positions in the subframe and positions of the memory cells of the respective subset based on the identification of the respective subset; and
updating pixel values of the pixels of the respective subset by pixel values of the subframe, wherein the positions of the memory cells of the respective subset in the set of memory cells correspond to the positions in the subframe according to the correlation, wherein
a number of the subsets in the predefined group is equal to or larger than 2;
a respective number of the memory cells in each of the subsets is smaller than a number of the memory cells in the set; and
each of the memory cells of the set corresponds unambiguously to a respective pixel of an image display device.

109. The apparatus according to claim 108, wherein each memory cell of the set is comprised in at least one of the subsets.

110. The apparatus according to claim 109, wherein each memory cell of the cell is comprised in only one of the subsets.

111. The apparatus according to claim 110, wherein
the pixels of the image display device are arranged in rows and columns; and
each of the subsets comprises memory cells corresponding to a diagonal line of the pixels of the image display device.

112. The apparatus according to claim 111, wherein the at least one processor, with the at least one memory and the computer program code, is arranged to cause the apparatus to further perform, for at least one of the subsets of the predefined group:
decompressing the received corresponding subframe to obtain a corresponding decompressed subframe; wherein
the pixel values of the pixels of the respective subset are updated by pixel values of the corresponding decompressed subframe.
